(19) United States
(12) Patent Application Publication
(10) Pub. No.: US 2018/0220815 A1
(43) Pub. Date: Aug. 9, 2018

(54) LAMINATED STAPLE

(71) Applicant: ALFA AUTOMATION S.R.L., Frazione Villa Selva FORLÌ (FC) (IT)

(72) Inventor: Giuseppe RAFFONI, FORLI (FC) (IT)

(21) Appl. No.: 15/595,009

(22) Filed: May 15, 2017

(30) Foreign Application Priority Data
Feb. 3, 2017 (IT) 102017000011805

(51) Int. Cl. A47G 1/10; F16B 15/00; F16B 12/24

(52) U.S. Cl. CPC A47G 1/105; F16B 15/0007; A47G 1/06; A47G 1/10; F16B 12/24

(57) ABSTRACT

An improved laminated staple (1) comprising a steel sheet bent as a “V” in a central portion thereof so as to form a central edge (12), two central walls (10, 20) diverging outwards from said central edge (12) and defining a first angle (α) therebetween, and a pair of ribs (30, 40) each extending laterally from said central walls (10, 20). The central walls (10, 20) and the ribs (30, 40) define a second angle (β) therebetween, which has a greater width than the width of said first angle (α).

### TECHNICAL FIELD

The present invention relates to the field of fastening elements, and in particular to fastening elements for wooden frame construction components. The present invention was developed in particular, although not exhaustively, in relation to an improved laminated staple for the corner jointing of wooden strips.

### EXISTING TECHNIQUE

In the production of frames and/or construction components and the like, it is known to corner joint the components of the constructions, e.g. the strips of a frame, using laminated staples which are inserted so as to straddle the jointing plane formed by placing the ends of strips to be jointed adjacent to each other.

There are available on the market laminated staples which comprise a steel foil which is bent so as to form two central walls which are perpendicular therebetween, and two end ribs which in turn are perpendicular to the walls and protrude outwards so that the staple takes on a substantially “W”-shaped profile. Staples of this type are described in patent documents U.S. Pat. No. 29,957, U.S. Pat. No. 4,681,498, U.S. Pat. No. 5,333,038, FR 2.318.715, FR 2.525.949 and ITBO990440. In order to facilitate the insertion of the staple into the strip, one of the edges of the staples with a “W” profile is sharpened.

In order to mutually joint two profiled strips, for example cut at a 45° angle, and to arrange them at right angle therebetween, said “W”-shaped staples are inserted straddling the jointing plane formed by arranging the strips adjacent to each other and so that the edge formed by the perpendicular walls and arranged on the centreline plane of the staple is on the jointing line of the strips to be jointed.

The insertion of the staples into the strips to be jointed is executed by mechanical devices, jointing machines, which comprise a loader, in which there are contained a plurality of staples merged into “a stick”, a punch which is particularly suitable for exerting a pushing force on a staple to eject it from the jointing machine, a guide plate on which the staples slide so as to take on the correct ejection position. In use, with the device positioned close to the jointing line of the two strips, the driver picks a single staple from the stick and, causing it to pass on the guide plate, pushes it outwards up to inserting it into the strips to be jointed.

Several experiments conducted by the Applicant have shown how the correct positioning of the staple on the guide plate is very precarious and how it may lead to an incorrect alignment of the staple and, accordingly, to difficulty in inserting the staple into the wood. This drawback is partly due to the geometry itself of the staple which has limited contact points with the guide plate, i.e. the part of plane comprised between the central walls and the outer corner comprised between said central walls and the outer ribs.

This drawback is further worsened by the prolonged use of the jointing machine which induces wear of the guide plate. The surface of the guide plate subjected to frequent friction due to the passage of the staples is modified over time up to causing the staple to take on an incorrect ejection position and therefore inducing difficulty of insertion into the wood, and/or a malfunctioning of the jointing machine.

Moreover, such wear may also affect the action of the driver which during the course of the operation thereof, could pick a staple after the one to be applied and positioned in the stick of staples contained in the loader. This drawback may cause frequent jamming of the jointing machine.

Therefore the need has arisen to provide an improved laminated staple for the corner jointing of wooden strips which allows increasing the reliability of the machinery and the devices used for the application thereof, which may be used also in large scale automated systems and which allows reducing the maintenance times of the jointing machines.

It is therefore the object of the present invention to provide a solution to such need and to overcome the limits of the laminated staples of known type.

### DESCRIPTION OF THE INVENTION

One embodiment of the present invention provides an improved laminated staple comprising a steel sheet bent as a “V” in a central portion thereof so as to form a central edge, two central walls diverging outwards from said central edge and defining a first angle therebetween, a pair of ribs each extending laterally from said central walls, the central walls and the ribs defining a second angle therebetween, characterized in that said second angle has a width greater than said first angle.

Due to such solution, the improved laminated staple comprises larger support points with respect to laminated staples of known type so that when the staple is positioned on a guide plate of a jointing machine, it may be kept in a correct position in an easier and more accurate manner.

Another aspect of the present invention provides for the first angle defined by the central walls to have a width equal to 90°.

A further object of the present invention provides for said ribs to define a support plane.

Another aspect of the present invention provides for said ribs to each comprise an end portion extending laterally from said ribs, the end portions and the ribs defining a third angle therebetween.

Due to such solution, the improved laminated staple has three contact points, and in particular three contact surfaces, with the surface of a guide plate of a jointing machine of known type, thus further increasing the positioning accuracy of the staple of the plate and reducing the wear of the latter.

Another aspect of the present invention provides for said third angle defined between the end portions and the ribs to have a width equal to that of said second angle defined between said central walls and said ribs.

Another aspect of the present invention provides for the ribs to have different sizes from one another.

Another aspect again of the present invention provides for at least one of the steel sheet portions to have a predetermined thickness of different value than the thickness value of the rest of the steel sheet.

Due to such solution, the displacement action that a laminated staple induces in the material of the strip in which it is inserted may be reduced, thus reducing the expansion and gaps generated in said material and improving the quality of the joint itself.

A further aspect of the present invention provides for said at least one portion of the steel sheet with different thickness to correspond to one of the end portions of the laminated staple.

Another aspect of the present invention provides for said thickness of the end portions to be smaller than the thickness value of the rest of the laminated staple.

Due to such solution, the end portions of the laminated staple, i.e. the ribs, create smaller tensions than in the material in which they are inserted, thus reducing the probability of generating gaps in the strips to be jointed.

### BRIEF DESCRIPTION OF THE DRAWINGS

Further features and advantages of the present invention will become apparent from the following description, given only by way of example, with reference to the accompanying drawings, in which:

FIG. 1 is a sectional view of a schematic representation of an improved laminated staple according to the present invention;

FIG. 2 is a sectional view of a schematic representation of a guide plate of a jointing machine and of the laminated staple in FIG. 1;

FIG. 3 is a sectional view of a schematic representation of a different embodiment of a guide plate of a jointing machine; and

FIG. 4 is a sectional view of a schematic representation of a further embodiment of an improved laminated staple according to the present invention;

FIG. 5 is a sectional view of a schematic representation of a guide plate of a jointing machine and of the laminated staple in FIG. 4;

FIGS. 6a and 6b are sectional views of schematic representations of a detail of a further embodiment of an improved laminated staple according to the present invention; and

FIGS. 7 and 8 are sectional views of schematic representations of further embodiments of an improved laminated staple according to the present invention.

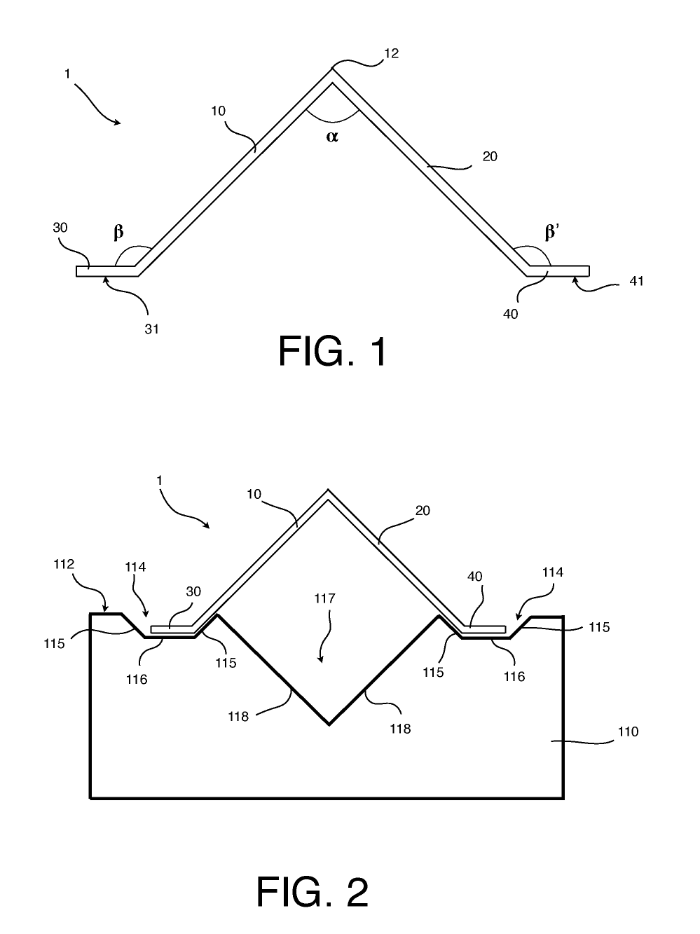

### IMPROVED METHOD FOR IMPLEMENTING THE INVENTION

A laminated staple 1 for the improved corner jointing of wooden strips according to the present invention comprises a steel sheet, for example but not exhaustively, having rectangular shape and bent as a “V” in a central portion thereof so as to form a central edge 12 and two central walls 10, 20 diverging outwards from said central edge 12. The bending of the laminated staple 1 is such whereby the two central walls 10, 20 define two planes defining a first angle α therebetween substantially equal to 90°. The end portions of the central walls 10, 20 are in turn bent outwards so as to define a respective rib 30, 40 which extends outside with respect to the central walls 10, 20. The ribs 30, 40 may have equal or different sizes to/from each other so that the extensions thereof may be equal to or different from each other. The bending of the ribs 30, 40 with respect to the central walls 20, 30 is such whereby the ribs 30, 40 define each a plane which is inclined with respect to the planes defined by the central walls.

According to one particularly advantageous feature of the present invention, the planes of the ribs 30, 40 and of the central walls 10, 20 define therebetween a respective second angle β, β′ having each a width greater than the width of the first angle α formed between the planes defined by the central walls 10, 20, preferably comprised between 130° and 140°, even more preferably equal to 135°.

Due to such configuration, the geometry of the improved staple of the present invention is substantially modified with respect to the staples of known type. Noting the cross-section of the improved plate 1, the ribs 30, 40 each define a support plane 31, 41 which significantly increases the contact surface of the improved staple 1 with a guide plate of a jointing machine, as is apparent below.

With particular reference to FIG. 2, a jointing machine of known type comprises a guide plate 110 configured to provide a support and guide element to a laminated staple 1. The inner surface 112 of the plate 110 comprises a plurality of recesses designed to house portions of a laminated staple, to position and guide it up to the ejection thereof. In particular, each inner surface 112 comprises a pair of end recesses 114 each defined by two inclined walls 115 and a flat bottom wall 116. Each inner surface 112 further comprises a central recess 117 defined by a pair of inclined walls 118. As is clearly apparent in the drawing, the end recesses 114 are configured to support the ribs 30, 40 of the laminated staple 1 and the central recesses 107, 117 are configured to support the ends of the central walls 10, 20 of the laminated staple 1.

It is therefore apparent that due to this configuration, the improved laminated staple of the present invention is suitable for being used also in existing jointing machines, i.e. on the market.

In use, when an improved laminated staple 1 according to the present invention is arranged on the guide plate 110, the end portion of the central walls 10, 20 rests on the most inner inclined wall 115 of the end recesses 114, and the ribs 30, 40 rest on the flat bottom walls 106, 116 of the end recesses 104, 114, each offering an extended support plane which facilitates the centring of the laminated staple 1 in the guide plate 110, also in the case of wear of the latter.

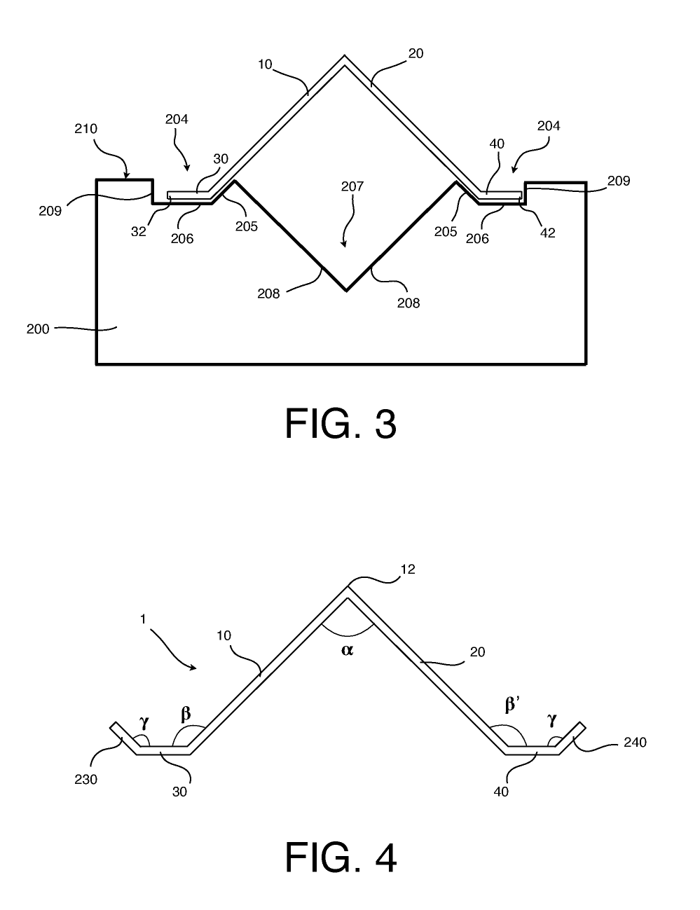

The present invention provides also an improved guide plate 200 for laminated staples. The improved guide plate 200, as shown in the embodiment in FIG. 3, comprises an inner surface 210 on which there are obtained a plurality of recesses designed to house portions of an improved laminated staple 1, to position it and guide it up to the ejection thereof. In particular, the inner surface 210 comprises a central recess 207 defined by a pair of inclined walls 208. The inner surface 210 further comprises a pair of end recesses 204. At least one of said end recesses 204 is defined by an inner inclined wall 205, a flat bottom wall 206 and a vertical outer wall 209. The other of said recesses 204 may be defined by a flat bottom wall 206, a vertical outer wall 209 and an inner inclined wall 205, or by a flat bottom wall 206 and a pair of vertical outer and inner walls, or again, by a flat bottom wall 206 and a pair of inclined outer and inner walls, or any other configuration of inner and outer walls described hereto.

In use, when an improved laminated staple 1 according to the present invention is arranged on the guide plate 200, the end portion of the central walls 10, 20 rests on the inclined wall 205 of the end recesses 204, and the ribs 30, 40 rest on the flat bottom walls 206 of the end recesses 204, and the end 42 of the improved laminated staple 1 abuts against the vertical wall 206. Thereby, the guide plate 200 has at least three centring points for the laminated staple 1, thus facilitating the positioning and centring of the laminated staple 1 on the guide plate 200.

According to a further embodiment of the present invention shown in FIG. 4, the improved laminated staple 1 comprises a steel sheet, for example but not exhaustively, having rectangular shape and bent as a “V” in a central portion thereof so as to form a central edge 12 and two central walls 10, 20 diverging outwards from said central edge 12. The bending of the laminated staple 1 is such whereby the two central walls 10, 20 define two planes defining a first angle α therebetween substantially equal to 90°. The end portions of the central walls 10, 20 are in turn bent outwards so as to define a respective rib 30, 40 which extends with respect to the central walls 10, 20. The ribs 30, 40 may have equal or different sizes to/from each other so that the extensions thereof may be equal to or different from each other. The bending of the ribs 30, 40 with respect to the central walls 20, 30 is such whereby the ribs 30, 40 define each a plane which is inclined with respect to the planes defined by the central walls. The planes of the ribs 30, 40 and of the central walls 10, 20 define therebetween a respective second angle β, β′ having each a width greater than the width of the first angle α formed between the planes defined by the central walls 10, 20, preferably comprised between 130° and 140°, even more preferably equal to 135°.

According to a particularly advantageous feature of the present invention, the end portion of the ribs 30, 40 is in turn bent so as to define a further end rib 230, 240. The bending of the end ribs 230, 240 with respect to the ribs 30, 40 is such whereby the end ribs 230, 240 define each a plane which is inclined with respect to the planes defined by the ribs 30, 40. The end ribs 230, 240 may have equal or different sizes to/from each other so that the extensions thereof may be equal to or different from each other. The planes of the ribs 30, 40 and of the end ribs 230, 240 define a third angle γ therebetween. The width of each third angle γ may take on different values according to the type of application. For example, as shown in the embodiment in FIG. 4, each third angle γ has a width substantially equal to the width of the second angles β, β′ formed between the planes defined by the central walls 10, 20 and the respective ribs 30, 40, preferably comprised between 130° and 140°, even more preferably equal to 135°.

Due to such configuration, the geometry of the improved staple of the present invention is substantially modified with respect to the staples of known type. Noting the cross-section of the improved plate 1, the ribs 30, 40 and the end ribs 230, 240 define respectively a support plane and a further support point which significantly increases the contact surface of the improved staple 1 with the guide plate of the jointing machine, as is apparent below.

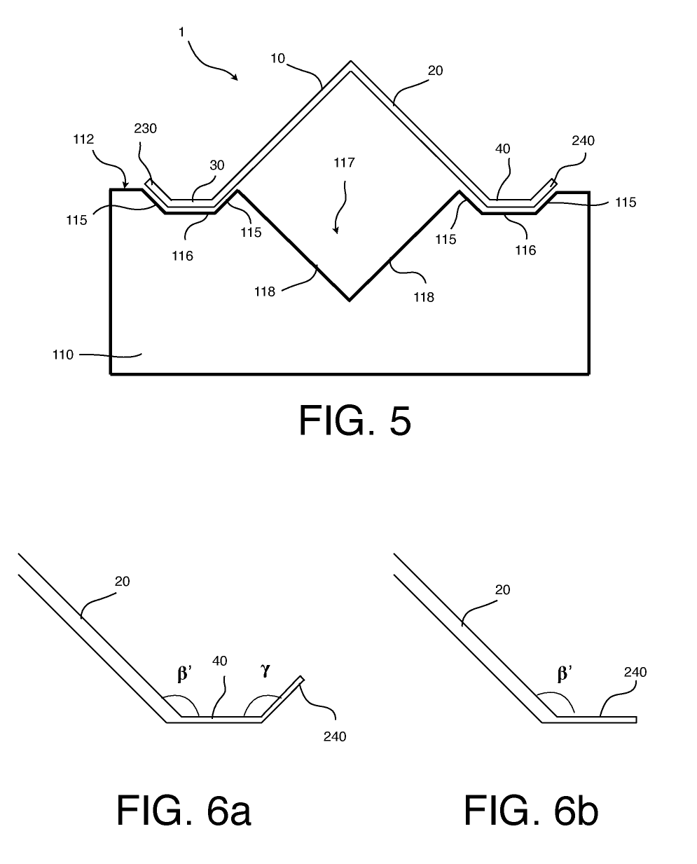

With particular reference to FIG. 5, when an improved laminated staple 1 according to the present invention is arranged on a guide plate 110 of known type, the end portion of the central walls 10, 20 rests on the most inner inclined wall 105, 115, the ribs 30, 40 rest on the flat bottom walls 106, 116 of the end recesses 104, 114, and the end ribs 230, 240 rest on the outer inclined walls 115, offering thereby three support points for the laminated staple 1 which facilitate the centring of the laminated staple 1 in the guide plate 110 also in the case of wear of the latter.

According to a further embodiment of the present invention, a laminated staple 1 for the improved corner jointing of wooden strips according to the present invention comprises a steel sheet, for example but not exhaustively, having rectangular shape bent as a “V” in a central portion thereof so as to form a central edge 12 and two central walls 10, 20 diverging outwards from said central edge 12. The bending of the laminated staple 1 is such whereby the two central walls 10, 20 define two planes defining a first angle α therebetween substantially equal to 90°.

The end portions of the central walls 10, 20 are in turn bent outwards so as to define a respective rib 30, 40 which extends outside with respect to the central walls 10, 20. The bending of the ribs 30, 40 with respect to the central walls 20, 30 is such whereby the ribs 30, 40 define each a plane which is inclined with respect to the planes defined by the central walls. The ribs 30, 40 may have equal or different sizes to/from each other so that the extensions thereof may be equal to or different from each other.

According to a particularly advantageous feature of the present invention, the steel sheet has different thicknesses, and in particular comprises at least one portion which has a predetermined thickness having a different value with respect to the thickness of the rest of the steel sheet.

Even more preferably, one or more of the end portions of the laminated staple may have a smaller thickness with respect to the thickness value of the remaining portion of the steel sheet. As shown in FIGS. 6a and 6b, the ribs 30, 40 and/or the end ribs 230, 240 have a smaller thickness, for example but not exhaustively, of value equal to 0.15 mm, with respect to the thickness of the main walls 10, 20, for example but not exhaustively, of value equal to 0.3 mm.

Naturally, the configurations and measurements described hereto may vary greatly so long as they resolve the same technical problem. The steel sheet may have several portions with different thickness therebetween, and said portions may be located in any point of the improved laminated staple 1.

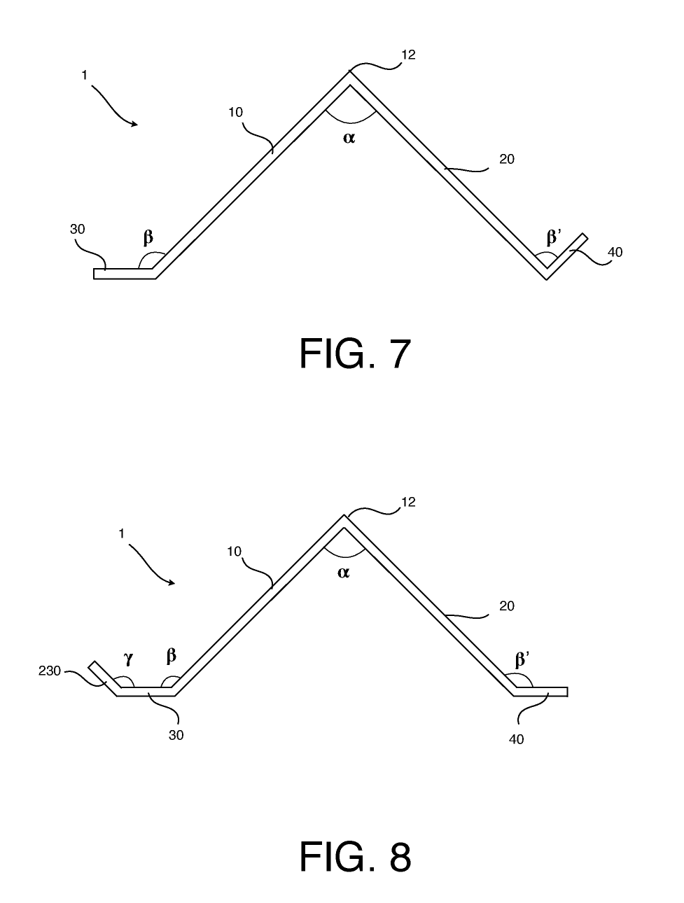

According to a further embodiment of the present invention shown in FIGS. 7 and 8, the improved laminated staple 1 comprises a steel sheet, for example but not exhaustively, having rectangular shape and bent as a “V” in a central portion thereof so as to form a central edge 12 and two central walls 10, 20 diverging outwards from said central edge 12. The bending of the laminated staple 1 is such whereby the two central walls 10, 20 define two planes defining a first angle α therebetween substantially equal to 90°. The end portions of the central walls 10, 20 are in turn bent outwards so as to define a respective rib 30, 40 which extends with respect to the central walls 10, 20. The bending of the ribs 30, 40 with respect to the central walls 20, 30 is such whereby the ribs 30, 40 define each a plane which is inclined with respect to the planes defined by the central walls. The ribs 30, 40 may have equal or different sizes to/from each other so that the extensions thereof may be equal to or different from each other. The planes of the ribs 30, 40 and of the central walls 10, 20 define a respective second angle β, β′ therebetween.

According to a particularly advantageous feature, one of said second angles β, β′ has a different width than the width of the other of said second angles β, β′. For example, a first rib 30 may define, with the respective central wall 10 thereof, an angle β equal to 135° as described above, and the second rib 40 may define, with the respective central wall 20 thereof, an angle β′ equal to 90°, as in the known technique.

According to this embodiment, the improved laminated staple 1 of the present invention may comprise also one rib 30 alone, the end portion of which is in turn bent so as to define a further end rib 230. As described above, the bending of this end rib 230 with respect to the respective rib 30 is such whereby the plane of the rib 30 and of the end rib 230 define a third angle γ therebetween. The width of the angle γ may take on different values according to the type of application. For example, the angle γ may have a width substantially equal to the width of the angle β formed between the planes defined by the central walls 10, 20 and the ribs 30, 40, preferably comprised between 130° and 140°, even more preferably equal to 135°.

Similarly, the improved laminated staple 1 may comprise both the end portions of the ribs 30, 40 bent so as to each define a further end rib 230, 240. The end ribs 230, 240 may have equal or different sizes to/from each other so that the extensions thereof may be equal to or different from each other. As described above, the bending of this end rib with respect to the respective rib is such whereby the plane of each rib and of each end rib define a respective third angle γ, γ′ therebetween. According to a particularly advantageous feature, one of said second angles γ, γ′ has a different width than the width of the other of said second angles γ, γ′.

In light of the above, any laminated staple which comprises even one rib and/or end rib alone bent according to one of the angles described above falls within the scope of the present invention.

All the details can be replaced by other technically equivalent elements. Similarly, any materials and also any contingent shapes and sizes may be used, depending on the needs, without departing from the scope of protection of the following claims.

1. Improved laminated staple (1) comprising a steel sheet bent as a “V” in a central portion thereof so as to form a central edge (12), two central walls (10, 20) diverging outwards from said central edge (12) and defining a first angle (α) therebetween, a pair of ribs (30, 40) each extending laterally from said central walls (10, 20), the central walls (10, 20) and the ribs (30, 40) defining a respective second angle (β, β′) therebetween, characterized in that said at least one of said seconds angles (β, β′) has a width greater than the width of said first angle (α).

2. Staple according to claim 1, characterized in that the first angle (α) has a width equal to 90°.

3. Staple according to claim 1, characterized in that said second angles (β, β′) have a width equal to each other.

4. Staple according to claim 1, characterized in that said ribs (30, 40) define a support plane (31, 41).

5. Staple according to claim 1, characterized in that at least one of said ribs (30, 40) comprises an end portion (230, 240) extending laterally from said rib (30, 40), the end portion (230, 240) and the rib (30, 40) defining a third angle (γ) therebetween.

6. Staple according to claim 5 characterized in that said third angle (γ) defined between the end portions (230, 240) and the ribs (30, 40) has a width equal to that of said second angle (β) defined between said central walls (10, 20) and said ribs (30, 40).

7. Staple according to claim 1, characterized in that the ribs (30, 40) have a size different from each other.

8. Staple according to claim 1, characterized in that at least one of the steel sheet portions has a predetermined thickness of different value than the thickness value of the rest of the steel sheet.

9. Staple according to claim 8, characterized in that said at least one portion of the steel sheet with different thickness corresponds to one of the end portions (30, 40, 340, 340) of the laminated staple (1).

10. Staple according to claim 9, characterized in that said thickness of the end portions (30, 340, 40, 340) is smaller than the thickness value of the rest of the laminated staple (1).
